(19) United States
(12) Patent Application Publication
(10) Pub. No.: US 2016/0342783 A1
(43) Pub. Date: Nov. 24, 2016

(54) VISUAL OBFUSCATION SECURITY DEVICE, METHOD AND SYSTEM

(71) Applicant: TENTO TECHNOLOGIES LTD, London (GB)

(72) Inventors: Howard James YATES, High Wycombe, Buckinghamshire (GB); Gordon Nigel BACKHURST, Leicester, Leicestershire (GB)

(21) Appl. No.: 15/112,055

(22) PCT Filed: Jan. 16, 2015
(86) PCT No.: PCT/GB2015/050101

§ 371 Date: Jul. 15, 2016

(30) Foreign Application Priority Data
Jan. 16, 2014 (GB) 1400691.0

(51) Int. Cl. G06F 21/34; H04L 29/06

(52) U.S. Cl. CPC G06F 21/34; H04L 63/06

(57) ABSTRACT

The present invention relates to a method for authenticating a user within a communications system. The method includes a portable computing device which captures a graphical counter-token; merges the graphical counter-token and a user token to generate an image revealing a visual key within the merged tokens; and displays the image to the user on the portable device. The graphical counter-token is initially generated by a server utilising the user token and the key. A system for authenticating a user is also disclosed.

### FIELD OF INVENTION

The present invention is in the field of security and authentication. More particularly, but not exclusively, the present invention relates to a security device for use in authenticating the identity of a user for online systems using visual obfuscation.

### BACKGROUND

In the modern connected world, individuals often need to prove their identity. For example, in online banking, to access their account, a user must provide at least a username and a password. Often a second form of authentication is required, such as a security token (for example, provided by a RSA SecurID dongle), a smart card, a security keypad, or the use of a biometric identifier, such as a fingerprint via a fingerprint scanner.

In one form of authentication, a code displayed on an authentication portal is provided to a specific security keypad for that user which then generates a counter-part code. This counter-part may be entered by the user within the authentication portal which can verify that the security keypad corresponding to the user has been used.

However, this method of authentication can be improved to increase security and to eliminate user error.

The inventor has previously invented an optical device which can be used with printed codes to reveal hidden keys using obfuscation. However, this optical device is less reliable at adapting to codes displayed on electronic displays because the optical device is of a fixed size and electronic displays differ in resolution and configuration. Furthermore, the optical device is designed such that the user token is visible to any holder of the optical device.

There is a need for an improved security device which can provide for both off-line and on-line authentication and an improved security or authentication method and system within communications systems.

It is an object of the present invention to provide a security device, method, and system which overcomes the disadvantages of the prior art, or at least provides a useful alternative.

### SUMMARY OF INVENTION

According to a first aspect of the invention there is provided a method for authenticating a user within a communications system, including:

a portable computing device:
capturing a graphical counter-token;
merging the graphical counter-token and a user token to generate an image revealing a visual key within the merged tokens; and
displaying the image to the user on the portable device;
wherein the graphical counter-token is initially generated by a server utilising the user token and the key.

The graphical counter-token may be captured from a terminal displaying the graphical counter-token. The terminal may receive the graphical counter-token from the server. The terminal may receive a user identifier from the user via an input device at the terminal and the server may use this user identifier to retrieve the user token to generate the graphical counter-token. A second server may manage communication between the terminal and the server. The terminal may receive the key from the user via an input device at the terminal. The terminal may transmit the key to the server, which may then verify the key. The server may also authenticate the user at a second server.

The user token may be retrieved from a memory at the portable device before being merged with the graphical counter-token.

The server may encode the counter-token using a user code. The portable computing device may decode the counter-token using the user code before merging the counter-token and the user token. The portable computing device may receive the user code from the user via an input device at the portable computing device.

The key may be generated at the server.

The graphical counter-token may be comprised of lighter pixels and darker pixels, and user token may be comprised of bits corresponding to lighter pixels and bits corresponding to darker pixels.

The merged tokens may reveal the visual key by one or more Boolean transformations such that the key is visible within lighter areas of the generated image.

The visual key may be formed of all the lighter pixels of the generated image.

The captured graphical counter-token and user token may be processed to align the tokens before merging.

The server may utilise the user token to generate the key before generating the graphical counter-token.

The visual key may comprise a plurality of the same character in a different style or font.

The server may encode the counter-token using a 2D barcode encoding method such as the QR (Quick Response) code method. The portable computing device may decode the counter-token using the 2D barcode encoding method before merging the counter-token and the user token.

According to a further aspect of the invention there is provided a system for authenticating a user within a communications system, including:
a server configured to generate a graphical counter-token for a stored token associated with the user utilising a key; and
a portable computing device configured to:
   capture the graphical counter-token;
   merge the graphical counter-token and a token associated with the user to generate an image revealing a visual key within the merged tokens; and
   display the generated image to the user on the portable device.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a security device in accordance with an embodiment of the invention;

FIG. 2: shows a block diagram illustrating an authentication system in accordance with an embodiment of the invention;

FIG. 3: shows a flow diagram illustrating a key reveal authentication method in accordance with an embodiment of the invention;

FIG. 4: shows a flow diagram illustrating an authentication method within a communication system in accordance with an embodiment of the invention;

FIG. 5: shows a flow diagram illustrating a key generation method in accordance with an embodiment of the invention;

FIGS. 6a, 6b, 6c, and 6d: show user tokens in graphical form illustrating contained characters in accordance with an embodiment of the invention;

FIG. 7: shows a flow diagram illustrating a counter-part token generation method in accordance with an embodiment of the invention;

FIG. 8a: shows a graphical counter-part token generated in accordance with an embodiment of the invention;

FIG. 8b: shows an encoded graphical counter-part token generated in accordance with an embodiment of the invention;

FIG. 9a: shows a graphical counter-part token captured by a security device in accordance with an embodiment of the invention;

FIG. 9b: shows a captured graphical counter-part token transformed by a security device in accordance with an embodiment of the invention; and

FIG. 10: shows an image generated from merged user and counter-part tokens illustrating a revealed key in accordance with an embodiment of the invention.

### DETAILED DESCRIPTION OF PREFERRED EMBODIMENTS

The present invention provides a device, method and system for authenticating the identity of a user.

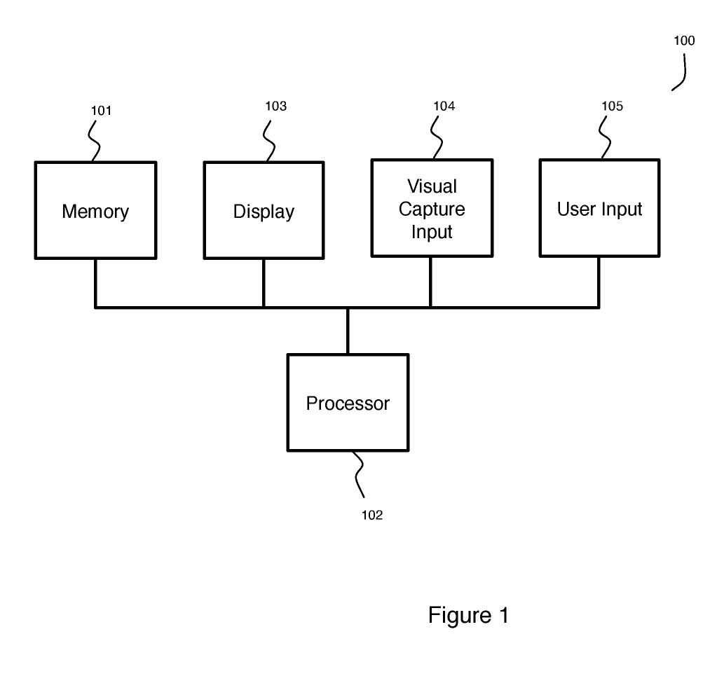

In FIG. 1, a security device 100 in accordance with an embodiment of the invention is shown.

The device 100 comprises a memory 101, a processor 102, a display 103, and a visual capture input 104.

The visual capture input 104 may be a camera.

The device may further include a user input 105.

The device 100 may be configured to be a multi-function portable device, such as a smart-phone, or a tablet computer.

The device 100 may be configured to capture a visual representation of a counter-part token via the visual capture input 104. The token may be comprised of pixels of differing brightness or differing colours. For example, black and white pixels, or red and yellow pixels.

In one embodiment, the counter-part token may also be encoded using a graphical encoding mechanism such as a 2D barcode (e.g. a QR code). This 2D barcode may then be decoded to create a counter-part token for merging.

The device 100 may be further configured to retrieve from the memory 101 a stored digital representation of a user token. In an alternative embodiment, the device 100 may be further configured to capture the user token, for example, using the visual capture input 104 from a digital or physical display.

The user token may be unique.

The device 100 may be further configured to merge the counter-part token and the user token to generate an image via additive means such that the pixels in a token that represent a darker portion cancel the overlaid pixels that represent a lighter portion.

In an alternative embodiment, any Boolean transformation such as XOR, NOR, NAND may be used to merge the counter-part token and user token to generate the image such that the key is visible within lighter areas of the generated image.

Furthermore, the image comprises a sequence of numeric characters, alphanumeric characters, or symbols formed by the remaining lighter pixels.

It can be seen that the graphical counter-part token, therefore, comprises the visual key but in a visually obfuscated form.

In one embodiment, the counter-part token has also been encoded with a user code. The device 100 may be configured to decode the counter-part token using the user code before merging the tokens. The user code may be requested from the user via the user input 105.

During the merging process, the device 100 may be configured to manipulate the captured counter-part token, the user token, or both to align the tokens.

The device 100 may be configured to display the image resulting from the merged tokens on the display 103.

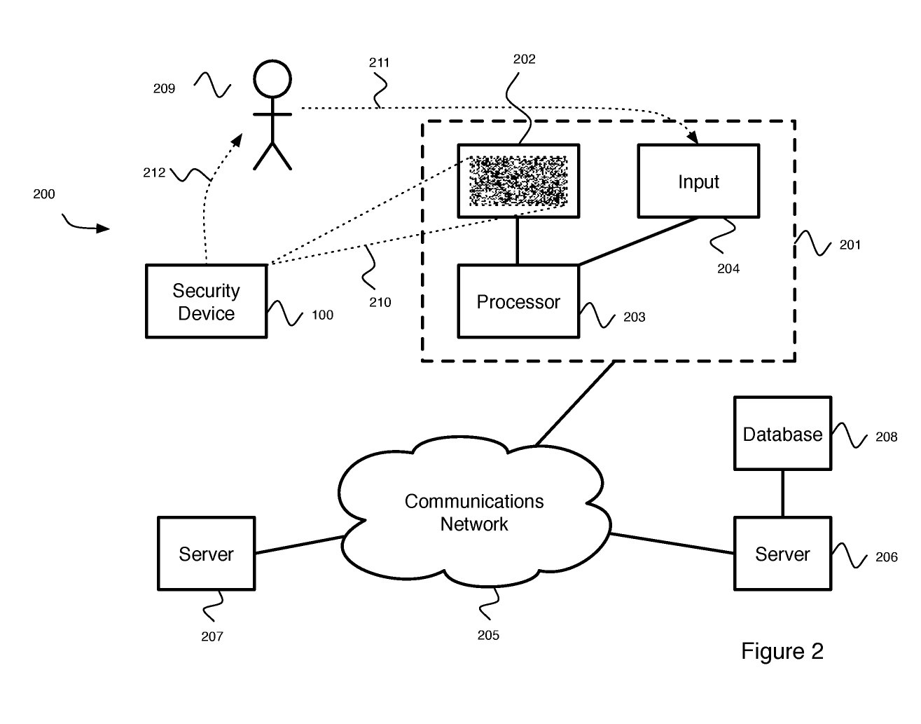

In FIG. 2, an authentication system 200 in accordance with an embodiment of the invention is shown.

The security device is shown at 100.

A terminal is shown at 201. The terminal may be a point-of-sale terminal, a personal computer, or any other apparatus.

The terminal comprises a display 202, a processor 203, and an input 204.

A communication network is shown at 205.

An authentication server is shown at 206.

A second server is shown at 207. This second server 207 may be a third party server such as an e-commerce server, web server, or other server.

The terminal 201 may be configured for requesting authentication from the first 206 or second 207 server. The request may include an identifier for the user of the security device 100. The user may provide the identifier via the input 204 at the terminal 201.

The second server 207 may be configured for transmitting the request to the first server 206.

The first server 206 may be configured for receiving the request and retrieving a user token from a storage 208. The first server 206 may be configured for generating a key utilising the user token. The first server 206 may then generate a graphical counter-token using the key and the user token, such that when the tokens are merged the key is revealed within the image created from the merger.

The first server 206 may encode the graphical counter-token using a stored user code which may be known only to both the first server 206 and the user 209.

In one embodiment, the first server 206 may encode the graphical counter-token into a 2D barcode such as a QR code.

The first server may be configured to transmit the graphical counter-token to the terminal.

The terminal 201 may be configured to display the counter-token for capture 210 by the security device 100 and to receive from the user 209 via 211 the input the key displayed 212 to the user at the security device 100. The key may be transmitted back to the first server 206. The first server 206 upon receiving the key may verify it and authenticate the user 209 if the key matches the generated key. The first server 206 may authenticate the user 209 by transmitting information back to the terminal 201 or to the second server 207.

In an alternative embodiment, the security device 100 may capture the graphical counter-token from a device other than the terminal 201 or from print.

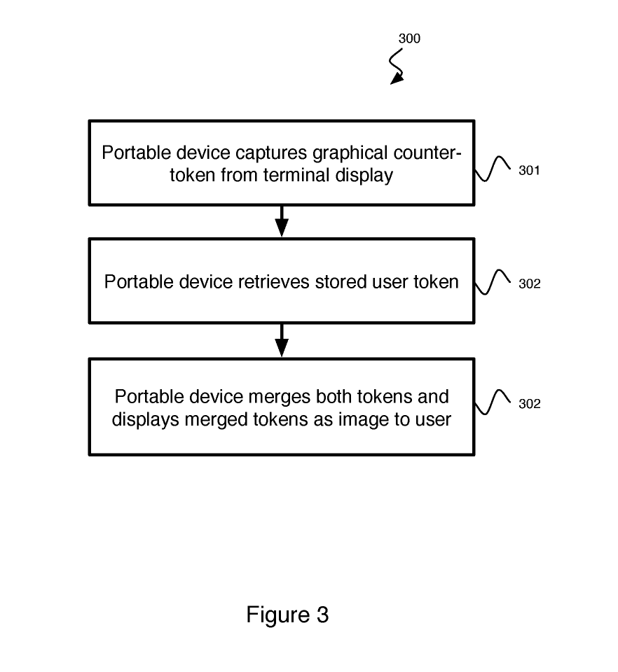

In FIG. 3, a key reveal method 300 in accordance with an embodiment of the invention is shown.

The security device 100 captures the graphical counter-token which may be displayed, for example, on the terminal 201 in step 301.

The security device 100 retrieves a user token, for example from a memory on the security device, in step 302.

The security device 100 merges both tokens and displays the image resulting from the merged tokens to the user 209 in step 303. Within the image formed by the merged tokens a key is revealed.

Where the graphical counter-token is encoded with a user code or into a 2D barcode such as a QR code, it may first be decoded before being merged with the user token.

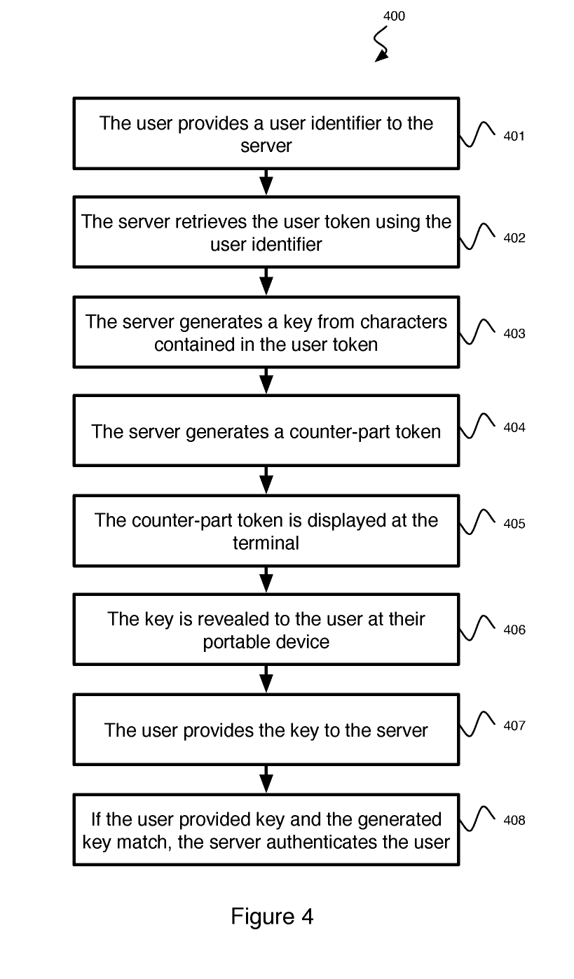

In FIG. 4, an authentication method 400 in accordance with an embodiment of the invention is shown.

In step 401, the user 209 provides a user identifier to the server 206, for example, via the input 204 at the terminal 201.

In step 402, the server 206 retrieves the user token for the user 209 using the user identifier.

In step 403, the server 206 generates a key from characters contained within the user token. The characters may be randomly selected from a list of possible characters contained in the user token.

In step 404, the server 206 generates a counter-part token that when merged with the user token reveals the key.

In step 405, the counter-part token is transmitted for display at the terminal 201.

In step 406, the key reveal method 300 may be used to display the key to the user 209.

In step 407, the user 209 provides the key to the server, for example, via the input 204 at the terminal 201.

In step 408, the server 206 verifies that the key provided matches the original key generated and authenticates the user 209.

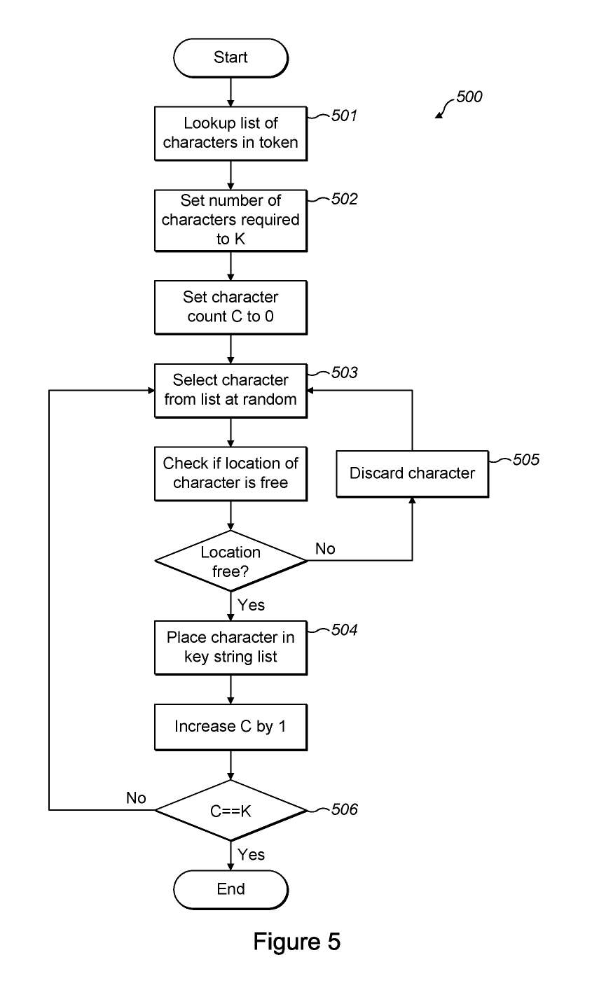

A method 500 of generating a key at the server 206 in accordance with an embodiment of the invention will now be described with reference to FIG. 5.

A list of characters contained within the user token is retrieved in step 501.

The characters may be defined by a font. The font may comprise different versions of the same character.

The number of characters for the key is specified in step 502.

Characters are selected from the list at random in step 503.

If the location of character is free (that is, not already forming part of, or obscuring, another character already in the string), the character is placed within a string in step 504, otherwise the character is discarded in step 505 and step 503 is repeated.

The process repeats until the string comprises the specified number of characters at 506. The resulting string forms the key. A key bitmap can be formed by defining bits (of the user token) which appear within the key characters as a part of the key bitmap.

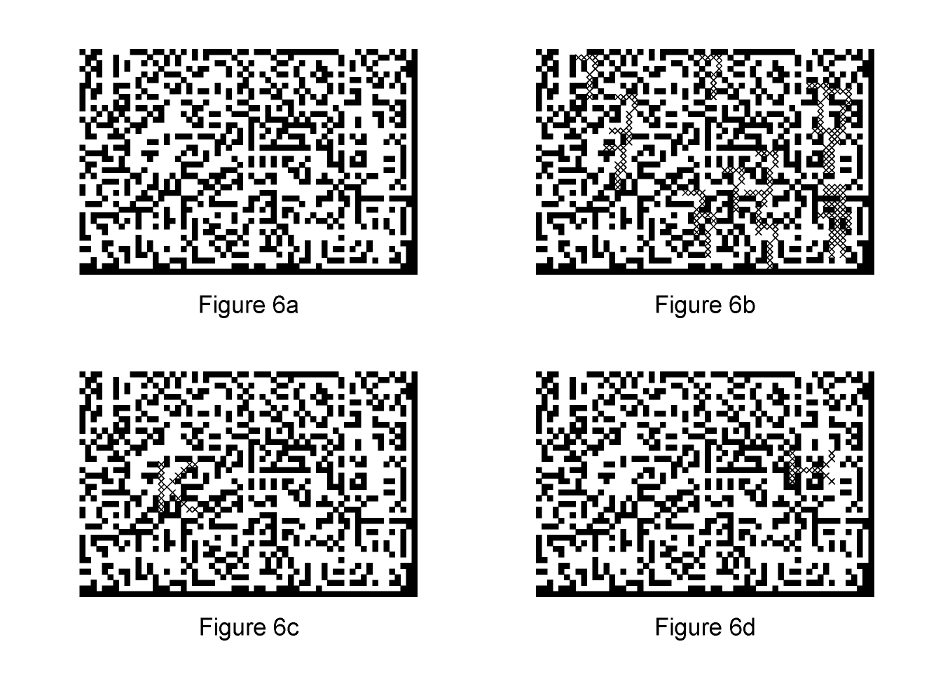

In FIG. 6a, an exemplary user token is shown.

In FIG. 6b, several character “7” s are shown contained in the user token as represented by the X marked pixels.

In FIG. 6c, a character “K” is shown contained in the user token as represented by the X marked pixels.

In FIG. 6d, an alternative character “K” is shown contained in the user token as represented by the X marked pixels.

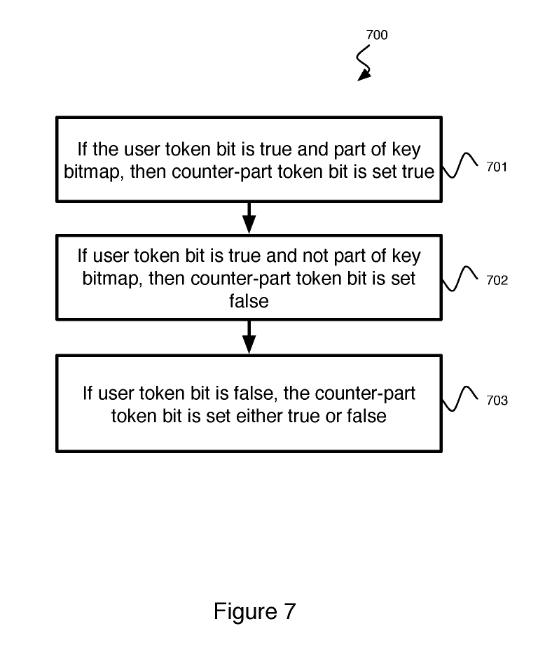

A method 700 of generating the counter-part token in accordance with an embodiment of the invention will now be described with reference to FIG. 7.

Once a suitable key has been generated a counter-part token may be generated which, when merged with the user token, will result in a pattern that will reveal the string of characters forming the key in the image form of the merged tokens.

In one embodiment, where the white pixels correspond to true bits and black pixels correspond to false bits to form a user token bitmap, the following steps are performed to generate the counter-part token:

In step 701, if User Token bit is true and is part of the bit map of the Key String then Counterpart Token bit is set to true.

In step 702, if User Token bit is true and is not part of the bit map of the Key String then the Counterpart Token bit is set to false.

In step 703, if the User Token bit is false the Counterpart Token bit may be set to either true or false (for example, randomly).

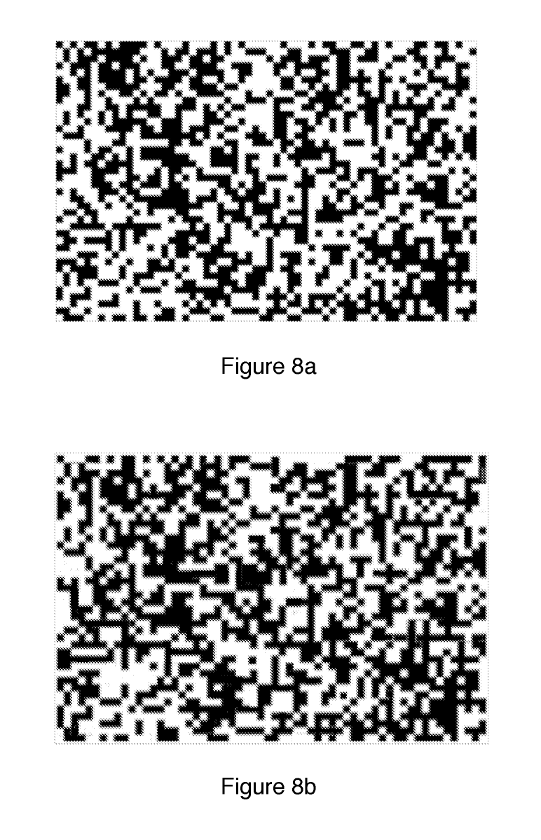

An exemplary counter-part token is shown in FIG. 8a.

The counter-part token may be encoded at the server 206 before transmission to the terminal 201 for display to the user 209. The token when encoded is shown in FIG. 8b. The counter-part token may be encoded using a user code known to both the server and the user.

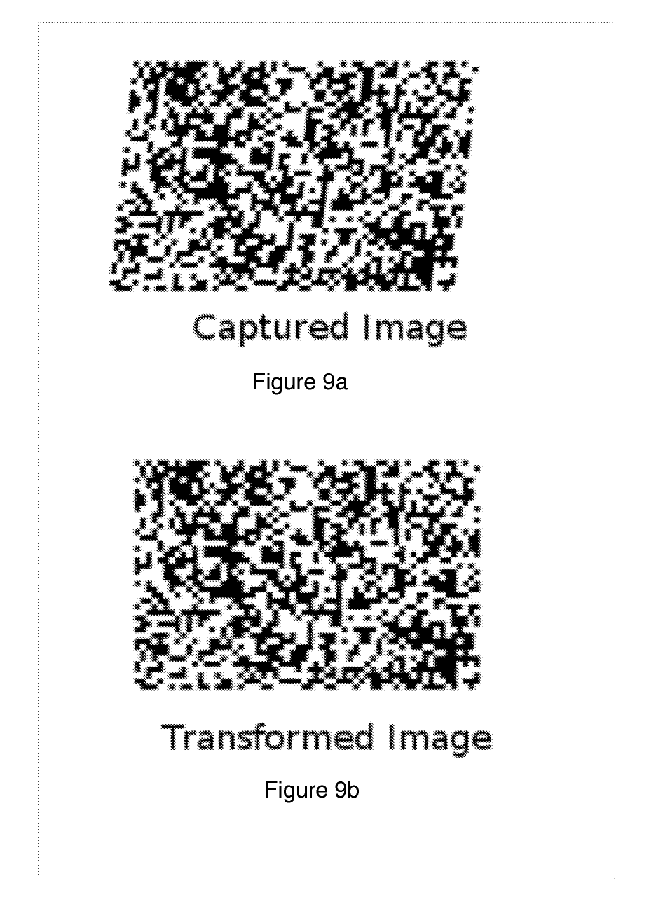

FIG. 9a shows the encoded counter-part token captured by the security device 100. During the capturing process, the image captured will, more likely than not, be distorted or skewed. To be able to merge this graphical token with the user token, the captured image may, therefore, need to be processed first.

Accordingly, the captured image may be transformed to correct the image for alignment and size to match the user token. The corrected image of the token in FIG. 9a is shown in FIG. 9b.

The corrected image may be processed in accordance with the following algorithm to convert the image into a bitmap:

Start BuildCounterpart
Set XN to N1 value for token
Set YN to N2 value for token
Find first row of image
Set x count to 0;
Set y count to 0;
<Row:>
Do

Go to first image pixel
<Image Pixel:>
Read image pixel
If pixel black the counterpart [x][y] = False
Else
counterpart [x][y]=True
increase value of y by 1
if y < YN go to next image pixel

Until end of row
If x < XN

Find next row
Goto Row:

Else

End BuildCounterpart

If the counter-part token was encoded, the user code may be used to decode the bitmap.

A method of merging the counter-part token and the user token will now be described.

In one embodiment, where white pixels have been processed into true bits and black pixels have been processed into false bits, the bitmap representing the counter-part token and a bitmap representing the user token may be merged into accordance with the following table which defines an additive means of processing:

| User Token Value | Counterpart Token Value | Merged Token Value |
|---|---|---|
| True | True | True |
| False | True | False |
| True | False | False |
| False | False | False |

The true bits within the merged token form white pixels and the false bits within the merged token form black pixels within the image generated from the merged token.

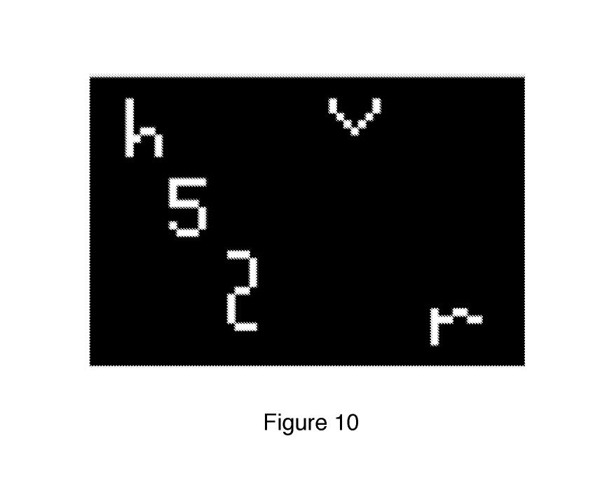

An example of an image generated from merged user and counter-part tokens is shown in FIG. 10. The key h52vr is visible in the image.

A potential advantage of some embodiments of the present invention is that the user token can be securely stored at the security device, two-factor authentication can be deployed using existing user hardware, legacy authentication mechanisms using non-dynamic display of counter-tokens and physical user tokens are supported, and the limitations of physical user tokens for use with dynamic displays are overcome.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for authenticating a user within a communications system, including:
a portable computing device:
capturing a graphical counter-token;
merging the graphical counter-token and a user token to generate an image revealing a visual key within the merged tokens; and
displaying the image to the user on the portable device;
wherein the graphical counter-token is initially generated by a server utilising the user token and the key.

2. A method as claimed in claim 1, wherein the graphical counter-token is captured from a terminal displaying the graphical counter-token.

3. A method as claimed in claim 1, wherein the user token is retrieved from a memory at the portable device before being merged with the graphical counter-token.

4. A method as claimed in claim 2, wherein the terminal receives the graphical counter-token from the server.

5. A method as claimed in claim 1, further including the step of the server encoding the counter-token using a user code.

6. A method as claimed in claim 5, wherein the portable computing device decodes the counter-token using the user code before merging the counter-token and the user token.

7. A method as claimed in claim 6, wherein the portable computing device receives the user code from the user via an input device at the portable computing device.

8. A method as claimed in claim 2, wherein the terminal receives a user identifier from the user via an input device at the terminal, and wherein the server uses this user identifier to retrieve the user token to generate the graphical counter-token.

9. A method as claimed in claim 2, wherein a second server manages communication between the terminal and the server.

10. A method as claimed in claim 1, wherein the key is generated at the server.

11. A method as claimed in claim 2, including the terminal receiving the key from the user via an input device at the terminal.

12. A method as claimed in claim 11, including the terminal transmitting the key to the server.

13. A method as claimed in claim 12, including the server verifying the key.

14. A method as claimed in claim 13, wherein the server authenticates the user at a second server.

15. A method as claimed in claim 1, wherein the graphical counter-token is comprised of lighter pixels and darker pixels, and user token is comprised of bits corresponding to lighter pixels and bits corresponding to darker pixels.

16. A method as claimed in claim 1, wherein the merged tokens reveal the visual key by one or more Boolean transformations such that the key is visible within lighter areas of the generated image.

17. A method as claimed in claim 1 wherein the visual key is formed of all the lighter pixels of the generated image.

18. A method as claimed in claim 1, wherein the captured graphical counter-token and user token are processed to align the tokens before merging.

19. A method as claimed in claim 1, wherein the server utilises the user token to generate the key before generating the graphical counter-token.

20. A method as claimed in claim 1, wherein the visual key comprises a plurality of the same character in a different style.

21. A method as claimed in claim 1, further including the step of the server encoding the counter-token using a 2D barcode encoding method.

22. A method as claimed in claim 21, wherein the portable computing device decodes the counter-token using the 2D barcode encoding method before merging the counter-token and the user token.

23. A system for authenticating a user within a communications system, including:
a server configured to generate a graphical counter-token for a stored token associated with the user utilising a key; and
a portable computing device configured to:
capture the graphical counter-token;
merge the graphical counter-token and a token associated with the user to generate an image revealing a visual key within the merged tokens; and
display the generated image to the user on the portable device.

24. A system as claimed in claim 23, further including:
a terminal configured to:
receive the graphical counter-token from the server; and
display the graphical counter-token; and
wherein the portable computing device captures the graphical counter-token from the terminal.

25. A system as claimed in claim 23, wherein the portable computing device is further configured to retrieve the token associated with the user from a memory at the portable computing device to merge with the graphical counter-token.

26. A server, terminal or portable computing device for use with the system of claim 23.

27. Computer-readable medium configured to store computer code which, when executed on a computing apparatus, is configured to perform the method of claim 1.

28. (canceled)
